(19) United States
(12) Patent Application Publication
(10) Pub. No.: US 2009/0121501 A1
(43) Pub. Date: May 14, 2009

(54) ASSEMBLED CHOPSTICKS

(76) Inventor: Ming-Huang LIU, Shengang Township (TW)

Correspondence Address: EGBERT LAW OFFICES, 412 MAIN STREET, 7TH FLOOR, HOUSTON, TX, 77002, US

(21) Appl. No.: 11/937,435

(22) Filed: Nov. 8, 2007

(51) Int. Cl. B25B 9/02

(52) U.S. Cl. 294/1.1; 294/99.2

(57) ABSTRACT

A chopstick assembly has a handle and a gripping portion with a connecting positioner therebetween. The connecting positioner has an external cylindrical member and a screw seat. A reduced diameter portion is received in a hole at an end of the handle. The screw seat is fitted within the external cylindrical member. The gripping portion has a stud and a columnar portion extending from and end thereof. The stud is threaded secured to the screw seat. The columnar portion is fitted within a wide diameter portion of the external cylindrical member.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to the structure of chopsticks, and more particularly to an innovative assembled chopsticks structure.

2. Description of Related Art Including Information Disclosed Under 37 CFR 1.97 and 37 CFR 1.98

Most people have dinner with unwashed dishware during outdoor activities, unwashed chopsticks being the most commonly used dishware for Chinese people.

With the growing awareness of environmental protection and increasing costs of raw materials in the international market, the price of chopsticks that do not require washing increases. So, some operators serve inferior unwashed chopsticks to consumers, which likely poses risks to the human body due to chemical substances (e.g. fluorescent materials) or excessive barbed scraps. Therefore, such disposable chopsticks are gradually phased out from everyday life.

Give the fact that long and pointy chopsticks are difficult for transport, the inventor has also developed another variation on an assembled chopsticks structure.

A typical example of an assembled chopsticks structure is shown in FIG. 1, wherein chopsticks 1 comprise a handle 10, a gripping portion 11 and a joint 12. Screw threads 121 at both ends of the joint 12 are screwed into the screw holes 101, 111 of the handle 10 and gripping portion 11 for assembly.

There are shortcomings are observed during actual application.

First, after disassembly of chopsticks 1, two chopsticks 1 are divided into two handles 10, two gripping portions 11 and two joints 12. Thus, more components are to be carried when the chopsticks 1 are shortened for transport. Moreover, owing to smaller size, the joint 12 may get lost easily during washing or collection, resulting in abandonment of chopsticks 1.

Second, while the chopsticks 1 are assembled, the screw threads 121 at both ends of the joint 12 are screwed separately into screw hole 101, 111 of the handle 10 and gripping portion 11. When the gripping portion 11 is loosened again, the joint 12 is likely rolled out synchronously with the gripping portion 11, or still linked to the handle 10, or disengaged from the handle 10 and gripping portion 11, leading to inflexibility of the chopsticks.

FIGS. 2 and 3 depict another assembled chopsticks structure. The chopsticks comprise upper section 13, lower section 14, nut 15 and bolt 16. The upper section 13 is provided with a hollow groove 130 for accommodating the lower section 14. A convex column 150 on top of the nut 15 is inserted into the bottom of hollow groove 130 of the upper section 13, whilst an upright column 160 at bottom of the bolt 16 is inserted into a trough 140 at top of the lower section 14.

There are other shortcomings are observed during actual application of this prior art structure.

First, since the nut 15 is adapted into the hollow groove 130 of the upper section 13 via only convex column 150, the nut 15 and upper section 13 likely loosen due to the limited tightness of the connection, heat expansion, and shrinkage. The twisting force is generated during loosening of the bolt 16. When the nut 15 is positioned insecurely and when the lower section 14 is loosened again, the nut 15 will be get loose or even get lost.

Alternatively, the nut 15 is positioned by pressing the radial point on the external wall of the upper section 13. In such a case, the holes on the external wall of the upper section 13 likely make chopsticks aesthetically unpleasing and dirty.

As mentioned above, the lower sections 13, 14 are positioned by screwing the bolt 16 and nut 15. Since the bolt 16 and the nut 15 are only screwed with bigger clearance, a displacement likely occurs between them. The assembly accuracy and quality of chopsticks will be affected due to absence of a guiding mechanism, which has been an important part of high-performance assembled chopsticks.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

While the embedding portion 311 of external cylinder 31 of the connecting positioner 30 is inserted into the through-hole 23 of the handle 20, the periphery of the female screw seat 32 is adapted tightly into a top section of the hole 310 of external cylinder 31. So, the embedding portion 311 of external cylinder 31 can be coupled more reliably and tightly, and the external wall of the handle 20 can also be positioned reliably without pressing the recessed holes, thus improving the aesthetical design and quality of combined chopsticks.

Also, the stud 41 of the gripping portion 40 is screwed into the screw hole 321 of the female screw seat 32, so the columnar portion 42 of the gripping portion 40 can be inserted into the bottom of the hole 310 of external cylinder 31 in a more reliable manner. The insertion improves chances for misalignment and displacement of chopsticks in comparison to the prior art, and the error caused by screwing can be compensated, enabling the gripping portion 40 to be coupled with the handle 20 reliably and coaxially.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of typical prior art assembled and detachable chopsticks.

FIG. 2 shows a sectional view of the typical prior art assembled and detachable chopsticks.

FIG. 3 shows another sectional view of the typical prior art assembled and detachable chopsticks.

FIG. 4 shows a perspective view of the present invention.

FIG. 5 shows an exploded perspective view of the present invention.

FIG. 6 shows a sectional view of the present invention.

FIG. 7 shows the second sectional view of the present invention.

FIG. 8 shows the third sectional view of the present invention.

FIG. 9 shows the fourth sectional view of the present invention.

FIG. 10 shows a perspective view of the application of the present invention.

FIG. 11 shows another perspective view of the application of the present invention.

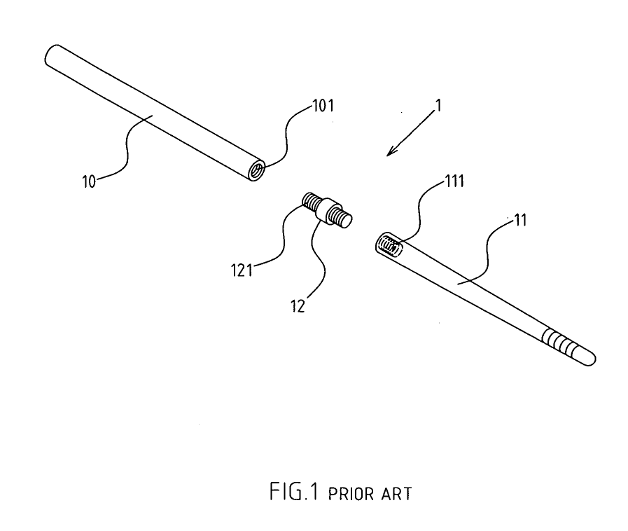

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

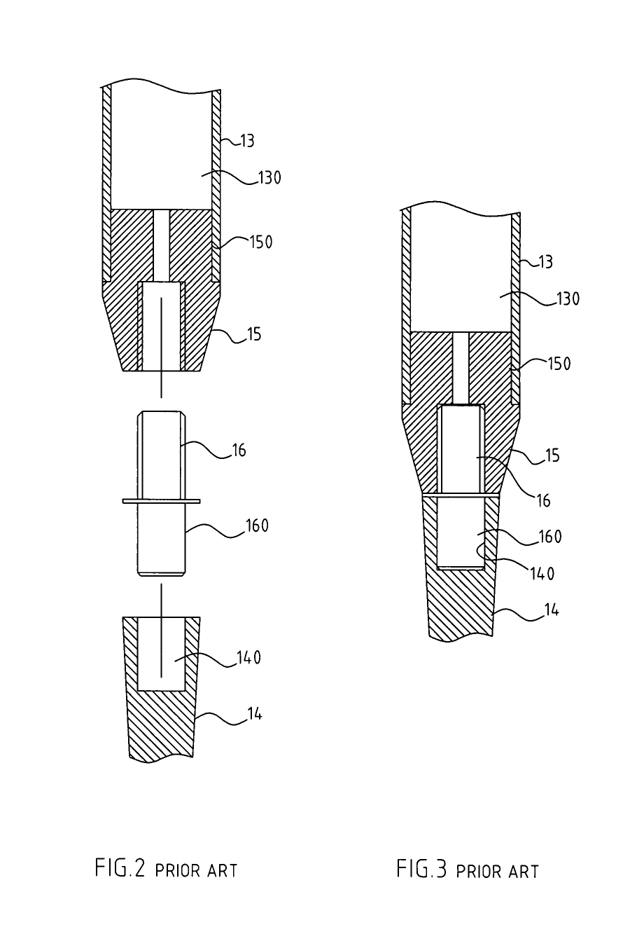

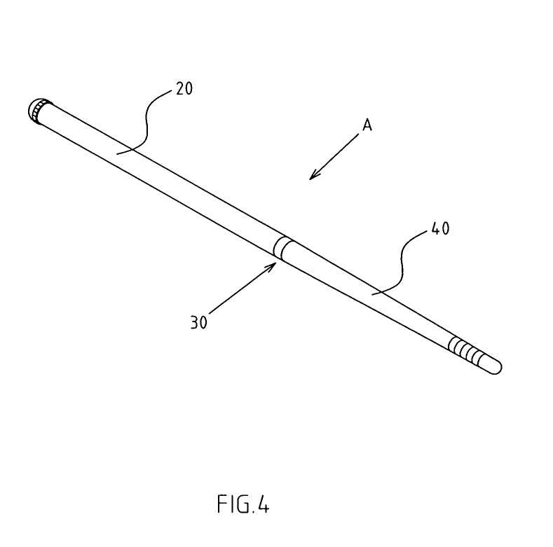

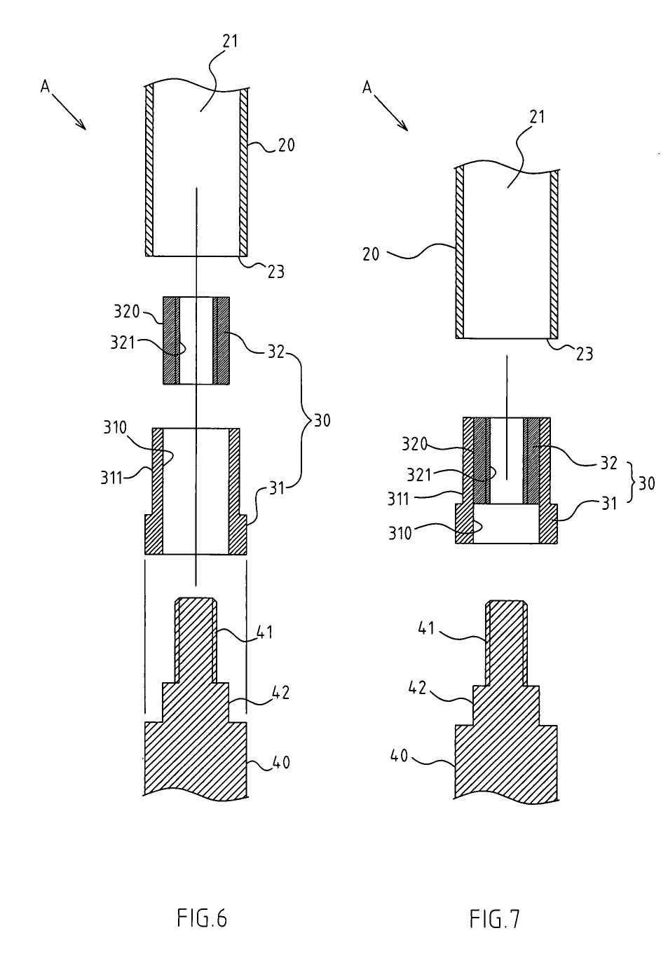

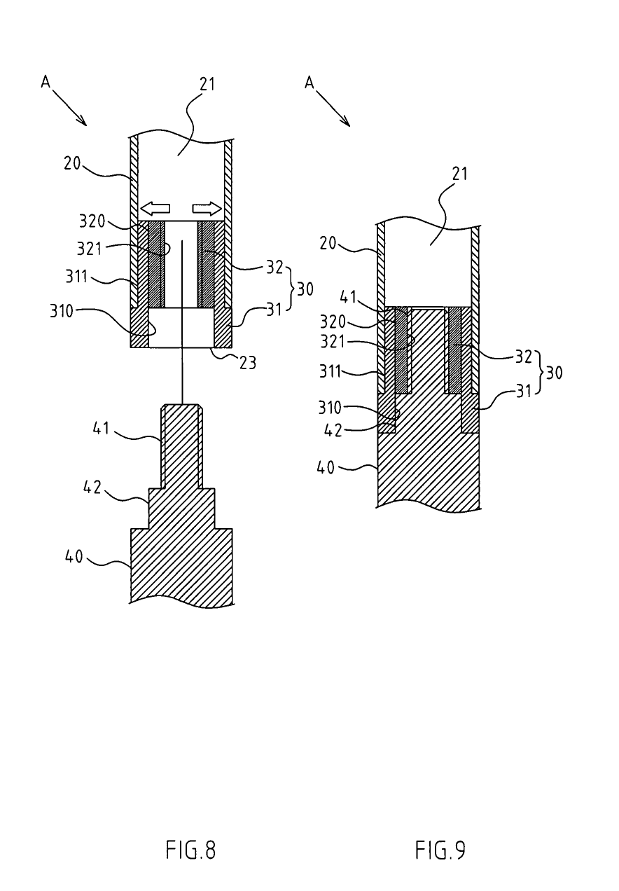

FIGS. 2-11 depict preferred embodiments of combined chopsticks structure of the present invention. The embodiments are provided only for explanatory purposes for the patent claims.

The chopsticks A comprise a handle 20, a connecting positioner 30 and a gripping portion 40.

The handle 20 is available with a through-type accommodating space 21. A movable cover 22 is assembled at top of the handle 20 to seal the accommodating space 21, and a through-hole 23 linked to the accommodating space 21 is assembled at bottom of the handle 20.

The connecting positioner 30 comprises an external cylinder 31 and a female screw seat 32. The external cylinder 31 of the female screw seat 32 is fitted with a hole 310. At the top of external cylinder 31, a reducing embedding portion 311 can be inserted into through-hole 23 at bottom of the handle 20. The periphery 320 of the female screw seat 32 is adapted securely onto the top of hole 310 of the external cylinder 31, while a screw hole 321 penetrates the center of the female screw seat 32.

The gripping portion 40 is where a stud 41 and a columnar portion 42 are protruded from a top thereof. The stud 41 is screwed into the screw hole 321 of the female screw seat 32. The columnar portion 42 can be inserted into the bottom of hole 310 of the aforementioned external cylinder 31.

The external cylinder 31 of the connecting positioner 30 is made of plastics, and the female screw seat 32 is made of metal materials. When the female screw seat 32 is inserted into the hole 310 of the external cylinder 31, a tight coupling can be achieved due to different material properties of the female screw seat 32 and external cylinder 31.

Based upon above-specified structures, the present invention is operated as follows:

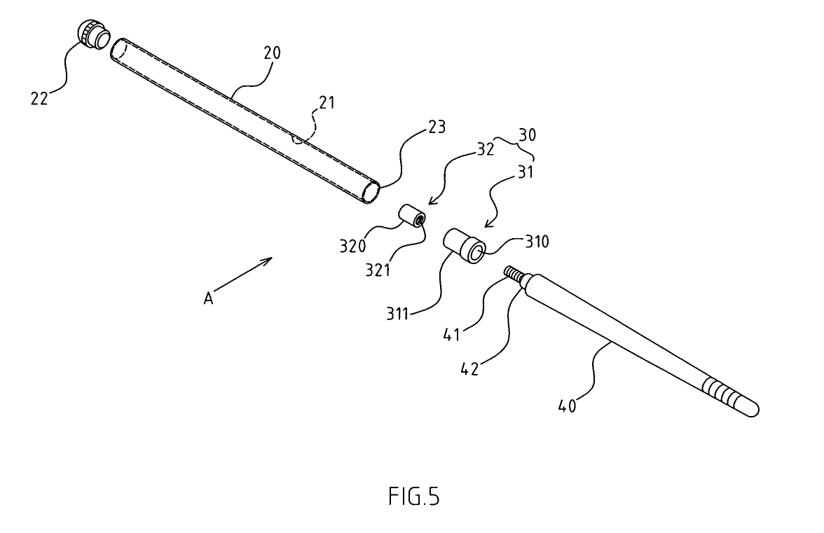

Referring to FIGS. 5-9, when using chopsticks A, the embedding portion 311 of the external cylinder 31 is inserted to the through-hole 23 of the handle 20. Then, the female screw seat 32 is tightly inserted into the hole 310 of the external cylinder 31, so that the periphery 320 of female screw seat 32 is adapted tightly to the hole 310. The tightness of the female screw seat 32 can expand the embedding portion 311 of external cylinder 31, so that the embedding portion 311 is adapted tightly to the inner wall of the accommodating space 21 to prevent the decline of adaptability of chopsticks A arising from heat expansion and shrinkage or arising from repeated screwing action. Finally, the stud 41 of the gripping portion 40 penetrates into the through-hole 23 of the handle 20, so that the stud 41 and the screw hole 321 of female screw seat 32 can be screwed securely. The stud 41 and columnar portion 42 are prefabricated onto one end of the gripping portion 40. So, when they are assembled at the bottom of the hole 310 of the external cylinder 31, the error caused by screwing of stud 41 and screw hole 321 can be compensated by the stepped difference of the columnar portion 42 (note: the axis center may misalign after screwing). Thus, the gripping portion 40 can be reliably and coaxially coupled with the handle 20.

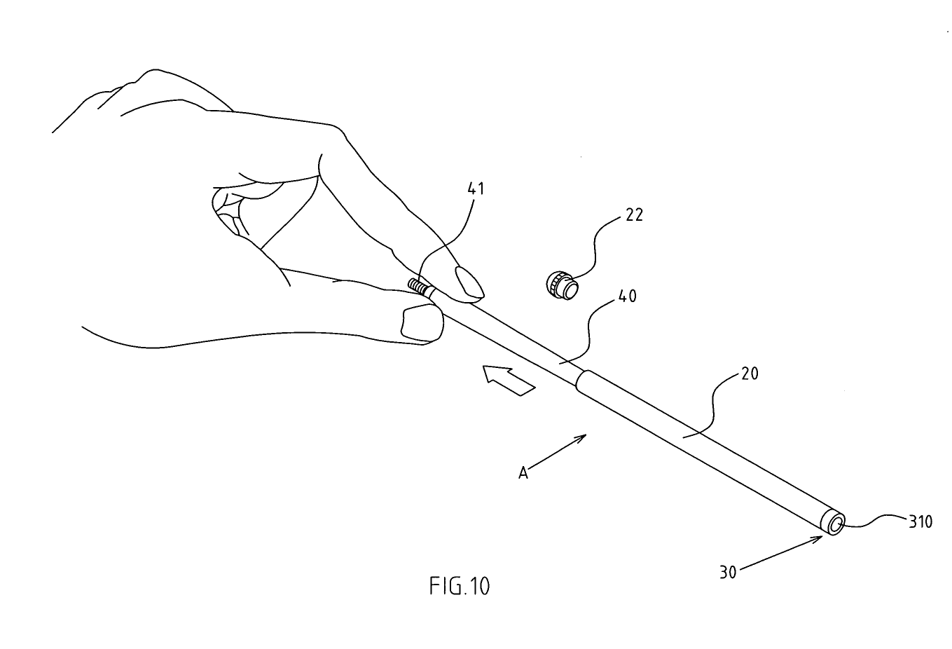

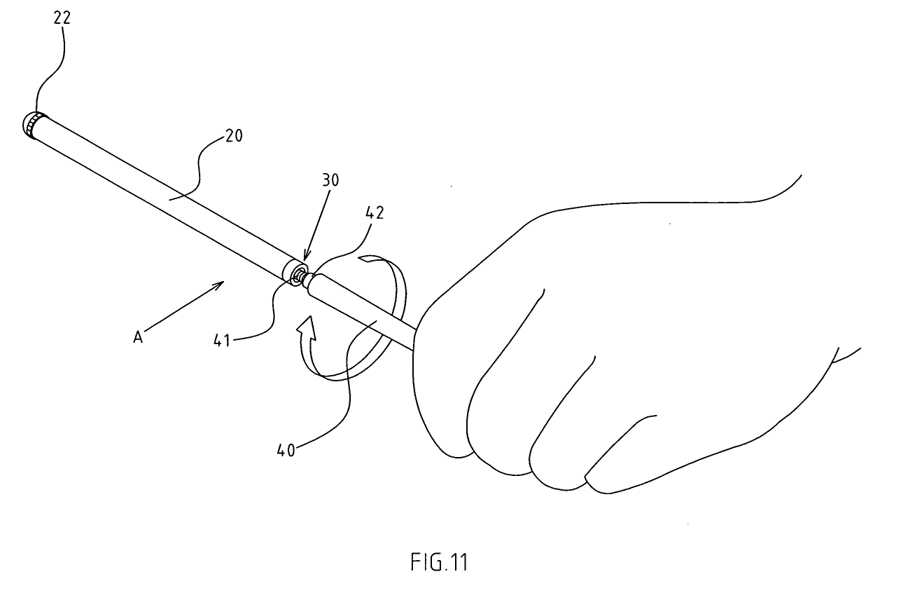

Referring to FIGS. 10-11, to disassemble said chopsticks A, the cover 22 at one end of the handle 20 of chopsticks can be removed, and then the disassembled gripping portion 40 is retracted into the accommodating space 21 of the handle 20. To use the chopsticks, the user may just take out a portion from the accommodating space 21 of handle 20 for reassembly, thus achieving convenient carrying and employment with improved applicability.

1-2. (canceled)

3. A chopstick assembly comprising:
a handle having an accommodating space extending longitudinally through an interior thereof, said accommodating space having a through hole opening at one end of said handle;
a cover affixed to an opposite end of said handle so as to close said accommodating space at said opposite end;
a connecting positioner affixed to said one end of said handle, said connecting positioner comprising:
an external cylindrical member having a hole extending therethrough, said external cylindrical member having a reduced diameter portion received in said through hole of said handle, said external cylindrical member having a wide diameter portion extending outwardly of said one end of said handle; and
a screw seat having a female thread formed on an interior thereof, said screw seat having an outer surface fitted within said hole of said external cylindrical member; and
a gripping portion having a stud and a columnar portion extending outwardly of an end thereof, said stud being threadedly engaged with said female thread of said screw seat, said wide diameter portion of said external cylindrical portion overlying said columnar portion.

4. The chopstick assembly of claim 3, said external cylindrical member being formed of a polymeric material, said screw set being formed of a metallic material.
